(19) United States
(12) Patent Application Publication
(10) Pub. No.: US 2015/0157098 A1
(43) Pub. Date: Jun. 11, 2015

(54) Folded Clothing Clip Holder

(71) Applicant: Oliver Eugene Stubblefield, Houston, TX (US)

(72) Inventor: Oliver Eugene Stubblefield, Houston, TX (US)

(21) Appl. No.: 14/098,791

(22) Filed: Dec. 6, 2013

(51) Int. Cl. A44B 99/00; G09F 23/00

(52) U.S. Cl. CPC A44B 99/00; G09F 23/00

(57) ABSTRACT

The present invention is a clip holder that can be applied to fabric or clothing, specifically shirts or underwear, designed to aid in maintaining the folded status of the garment. The clip holder has two horizontal, parallel posts with space between them on one side, which descend or curve down on the same end and then converge to form a single post in the center, which then turns horizontally in the same direction as the two posts above and is almost parallel to the two posts. From a side view, the shape of the holder appears as a “U” shape, which narrows at the opening compared to the interior of the holder. It is this narrowing that enhances the gripping ability of the holder on the folded garment. Because the narrower single post fits between the top posts, two folded garments with the present invention applied become easily stackable.

The present invention is a folded clothing clip holder, referred later as clip holder or holder, designed to maintain the folded status of fabric, underwear, socks or shirts. The clip holder, which is composed of a flexible material such as polyurethane, plastic, nylon, or metal, is applied to a folded shirt at the collar and the center of the fold or evenly at the shoulders using two holders to maintain the folded status of the cloth, underwear or garment. This clip holder has two horizontal parallel posts on one side that descend or curve down and then converge after the curve forming a single post which again curves horizontally in the same direction as the to posts above it, running almost parallel with the two posts. The narrower single post is also visibly centered between the two posts and is slightly longer as well. From the side view, the top posts and bottom post converge slightly to create a smaller spacing at the opening compared to the interior of the clip holder. The narrow spacing helps to secure the placement of the holder while maintaining the garment's folded state making the garment more neatly stackable and also maintaining the folded status if the stacked clothing or other items are knocked over or dropped.

### BACKGROUND OF INVENTION

In today's society when the production and acquisition of many goods and services occurs at very affordable rates, people often buy things for the variety or just because they are on sale. Even for those with exquisite tastes, who only buy high-end clothing, they almost all need help organizing or helping to maintain an organized appearance of the garments that they acquire. Whether it is a lot or a small amount, the clothing, particularly the folded garments, eventually reach a state of disarray for the normal common individual. The reach this state because people don't take the next garment or shirt on the top of the folded stack. Even if they attempted to do so, that shirt would not always coordinate with what the person is preparing to wear. Therefore they must move the garments around to get the one they want. In doing so, the stacked garments eventually become unfolded and inevitably unorganized.

This is the concept of the present invention. It is designed to help maintain the folded status of the fabric, garment or underwear on which it is applied. When applied to the folded garment, it lessens the likelihood of total disarray of the stack of folded garments by maintaining the folded state of each item. Even if the stack falls or is knocked over, the applied present invention maintains the folded state of the garment and allows it to be easily restacked without needing to be refolded. The present invention also makes the organization of the folded garments easier because of a feature that makes the garment more evenly stackable when it is applied in the same location on each folded garment.

U.S. Pat. App. Pub to Blitstein et al. U.S. 2005/0125960 A1 is a baby blanket clip designed to keep the blanket attached to the carriage. However, although the components of the design were only slightly similar this invention was designed to hold fabric in place on an apparatus and not a stand-alone application. There were no other designs to do what the present invention is designed to do.

### SUMMARY OF INVENTION

The present invention is a clip holder that can be applied to fabric or clothing, specifically shirts or underwear, designed to aid in maintaining the folded status of the garment. The holder has two horizontal, parallel posts with space between them on one side, which descend or curve down on the same end and then converge to form a single post in the center, which then turns horizontally in the same direction as the two posts above and is almost parallel to the two posts. From a side view, the shape of the holder appears as a “U” shape, which narrows at the opening compared to the interior of the holder. It is this narrowing that enhances the gripping ability of the holder on the folded garment. The narrower single post also fits between the top posts when two folded garments with the present invention applied are stacked one on top of the other.

### BRIEF DESCRIPTION OF THE DRAWINGS

The present invention and complete understanding thereof will become more apparent as the description is given of the drawings.

FIG. 1A is a top view of the holder.

FIG. 1B is a perspective view of the holder.

FIG. 2A is the back view.

FIG. 2B is a view from the front of the holder opposite of FIG. 2A.

FIG. 2C is a side view of the holder.

FIG. 2D is a view of two stacked holders.

FIG. 3A is a perspective and topside view of the holder attached to a sample garment in folded state in the center of the collar.

FIG. 3B is the opposite side view of the FIG. 3A.

FIG. 4A is a topside or perspective view of the holder attached to a sample folded garment at two points (the shoulder) of the garment.

FIG. 4B is an opposite view of FIG. 4B.

### DETAILED DESCRIPTION OF THE INVENTION

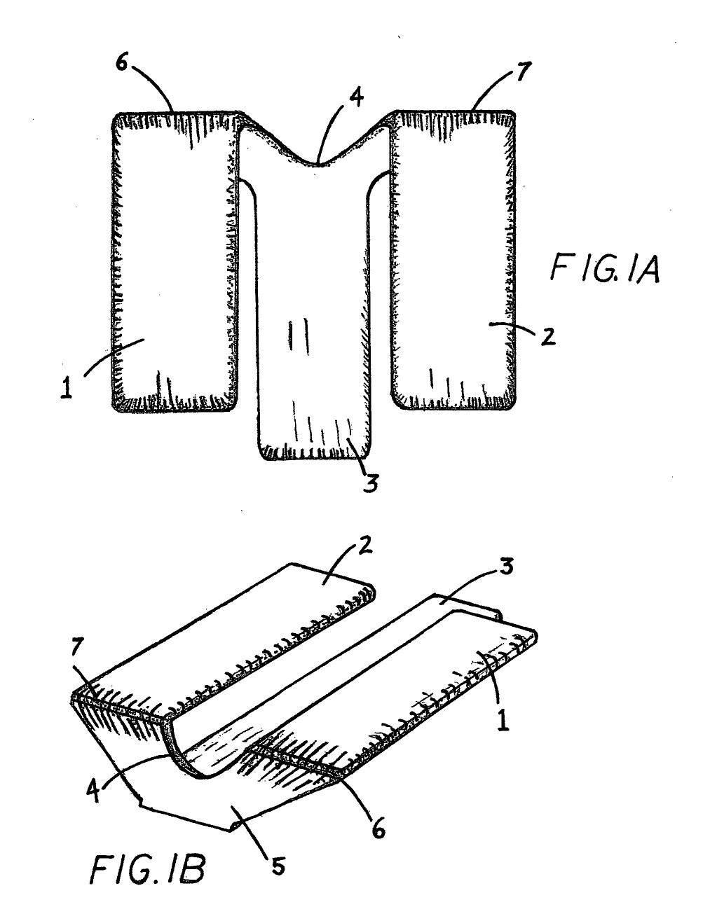

FIG. 1A shows a top view of the clip holder. This view shows the features designated as 1, 2, 3, 4, 6 and 7. Features 1, 2, and 3 show the posts of the holder. The top posts, 1 and 2, are the same width, length, are parallel and are oriented in the same direction. 3 is smaller in width but longer than 1 and 2 and centered between 1 and 2 according to the perspective of FIGS. 1A. 1 and 2 descend at points 6 and 7 and converge to form a concave spacing indicated as feature 4.

FIG. 1B is the perspective view that shows feature 5 formed as 1 and 2 descend at points 6 and 7 to create 5 and form feature 4. Also indicated by this view is the more elongated post, which is feature 3.

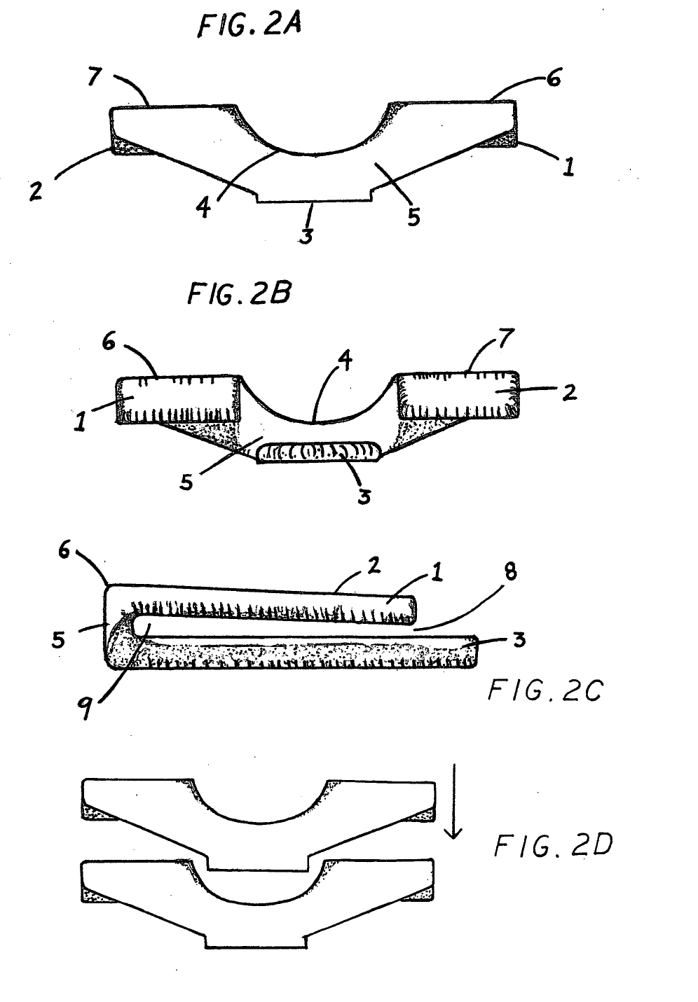

FIG. 2A is the back view of the holder. The properties and components of this view are the same as FIG. 1A and FIG. 1B. Feature 3 is indicated to show the area where 3 is located in this view.

FIG. 2B is the opposite view of FIG. 2A. It also indicates the components of the holder described in FIG. 1B and FIG. 2A. In the view, 3 is positioned and centered between 1 and 2.

FIG. 2C is a side view of the holder. From this perspective, the top post(s) indicated as feature 1 (and 2) is shown to not be parallel to the bottom post indicated as feature 3. Shown is the narrowing of the holder at the opening indicated as feature 8. It narrows compared to the interior space of the holder indicated as component 9. Also indicated by this perspective of FIG. 2C is the consistent thickness of the clip holder at most points. This narrowing of the spacing from the interior, 9, to the opening, feature 8, of the holder is to more securely grip the fabric or garment on which it is applied.

FIG. 2D is a back view of the holder such as FIG. 2B. This view is of two holders as they would appear if they were applied to garments and stacked in a folded state with the arrow indicating the direction for stacking.

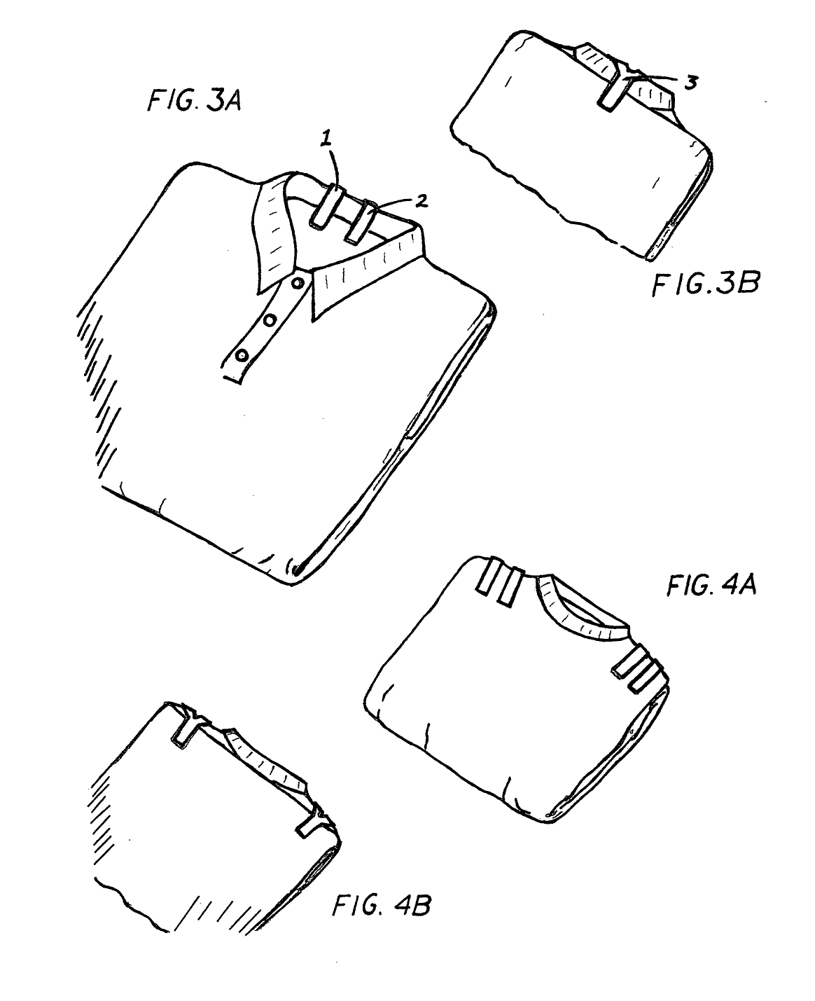

FIG. 3A is a view of the invention being applied to a folded garment, for example a folded shirt, in the center. Visible are the two top posts, features 1 and 2, of the holder over the collar of the folded garment.

FIG. 3B is the opposite view of FIG. 3A. It shows the holder applied to the folded garment with feature 3, the bottom post, on the underside of the shirt being visible.

FIG. 4A is the perspective view of another folded garment with two holders, described in FIG. 1A attached at two positions (the shoulders) near the neck of the folded garment.

FIG. 4B is the opposite view of FIG. 4A. It shows feature 3, the single post, of the two holders attached to the underside of the folded garment. It shows the folded garment being held in place at the shoulders of the shirt. The above-described present invention may be formed from metal, plastic, polyurethane, or nylon to aid in the flexibility of the invention for its most effective application.

This present invention is an improvement over any existing ideas of organization of garments to help maintain the folded status of fabric, garments, or underwear. There are modifications that may be made thereunto the present invention without departing from the spirit and scope of the invention.

What is claimed is:

1. A holder for maintaining the folded status of fabric or garment comprising:
Two horizontal, parallel top posts with space between them that descend and then converge to form a third post;
A third post that is almost parallel to the top posts that is positioned between the two top posts;
A curved or flat back section of the invention from which the top two posts and bottom post protrude;
Top posts that angle towards a bottom post to create narrower spacing or a more narrowed opening compared to the interior spacing of the holder or the back part from which the posts protrude;
A narrower opening to create friction to maintain placement of the holder on fabric or a garment on which it is applied;

2. A holder according to claim 1 wherein the holder is made of a flexible material such as plastic, polyurethane, nylon, or metal to accommodate the thickness of various fabrics or garments.

3. A holder according to claim 1, wherein the interior surface may or may not be textured to frictionally grip fabric or an article of clothing.

4. A holder according to claim 1, wherein the exterior or interior surface may have affixed to it or engraved in it a logo or trademark.

5. A holder according to claim 1, wherein the two top posts or the bottom post may be adjusted to match the design of the opposite post of the holder.

6. A holder according to claim 1, wherein the spacing of the two posts and the aperture formed on the back of the holder create an additional feature of being stackable for two or more holders.
